(19) United States
(12) Patent Application Publication
(10) Pub. No.: US 2020/0113149 A1
(43) Pub. Date: Apr. 16, 2020

(54) PET CASE

(71) Applicant: GUANGDONG BOYU GROUP CO., LTD, Chaozhou City (CN)

(72) Inventors: Youkai YU, Chaozhou City (CN); Bingyan YU, Chaozhou City (CN); Jianqin YU, Chaozhou City (CN)

(73) Assignee: GUANGDONG BOYU GROUP CO., LTD, Chaozhou City (CN)

(21) Appl. No.: 16/597,451

(22) Filed: Oct. 9, 2019

(30) Foreign Application Priority Data
Oct. 10, 2018 (CN) 201821642540.X

(51) Int. Cl. A01K 1/00

(52) U.S. Cl. CPC A01K 1/00

(57) ABSTRACT

Provided is a pet case. The pet case includes at least two case bodies fitted together. Two adjacent case bodies of the at least two case bodies are communicated to each other, a first connector is arranged between the two adjacent case bodies, and the first connector is connected to a side plate of each of the two adjacent case bodies. The at least two case bodies are combined to form the pet case through the first connector, which may increase the space of the pet case on the basis of effectively using the original pet case, avoid a situation that the original pet case is abandoned due to the sufficiency of space in the pet case and the replacement of a new pet case, and increase utilization ratio of the original pet case.

### CROSS-REFERENCES TO RELATED APPLICATIONS

This application claims priority to Chinese patent application No. 201821642540.X, filed on Oct. 10, 2018, the disclosure of which is incorporated herein by reference in its entirety.

### TECHNICAL FIELD

The present disclosure relates to the technical field of pet raising tool and, in particular, relates to a pet case.

### BACKGROUND

At present, the structures of most pet cases in the market are an integral structure, that is, the pet cases can not be disassembled. This causes the pet cases extremely inconvenient to carry. Moreover, the pet cases occupy a large area during transportation, which not only increases the cost of transportation, but also causes the risk of damage to the pet cases if there is a slight collision during transportation. During disinfection and cleaning, corners and gaps of the pet cases are difficult to deal with, causing the cleaning extremely inconvenient.

In addition, the size of such pet case is fixed, so when a pet raised in the pet case grow up, the space of the pet case will not be enough for the pet to move around freely in the pet case, and thus the pet case needs to be replaced by a new pet case with a larger space. This increases the cost of a pet owner, and result in waste caused by the unavailability of the original pet case with a small space.

### SUMMARY

An objective of the embodiment of the present disclosure is to provide a pet case whose internal space can be adjusted.

To achieve the above objective, the present disclosure adopts a following technical solution.

Provided is a pet case, which includes at least two case bodies fitted together. Two adjacent case bodies of the at least two case bodies are communicated to each other, a first connector is arranged between the two adjacent case bodies, and the first connector is connected to a side plate of each of the two adjacent case bodies.

In one embodiment of the present disclosure, the first connector is provided with a first mounting groove corresponding to the side plate of the each of the two adjacent case bodies.

In one embodiment of the present disclosure, a sidewall of the first mounting groove is provided with a first elastic sealing bulge along a length direction of the first mounting groove.

In one embodiment of the present disclosure, a bottom plate of each of the at least two case bodies is provided with a first fixed rod corresponding to the first connector, the first connector is provided with a first through-hole corresponding to the first fixed rod, and the first fixed rod is configured to pass through the first through-hole.

In one embodiment of the present disclosure, a first screw hole is arranged at each of both ends of the first fixed rod, and the bottom plate and a top plate of each of the at least two case bodies are respectively provided with a fixed bolt corresponding to the first screw hole.

In one embodiment of the present disclosure, a second connector is arranged between two adjacent side plates of each of the at least two case bodies, and the second connector is L-shaped. In one embodiment of the present disclosure, the second connector is provided with two second mounting grooves respectively corresponding to the two adjacent side plates.

In one embodiment of the present disclosure, a bottom plate of each of the at least two case bodies is provided with a second fixed rod corresponding to the second connector, the second connector is provided with a second through-hole corresponding to the second fixed rod, and the second fixed rod is configured to pass through the second through-hole.

In one embodiment of the present disclosure, a sidewall of each of the two second mounting groove is provided with a second elastic sealing bulge along a length direction of the each of the two second mounting groove.

In one embodiment of the present disclosure, the side plate is made of an acrylic plate or a tempered glass plate, and an edge position of the side plate is provided with a protective border. The present disclosure has the following beneficial effect: the at least two case bodies are combined to the pet case through the first connector, which may increase the space of the pet case on the basis of effectively using the original pet case, avoid a situation that the original pet case is abandoned due to the insufficiency of space in the pet case and the replacement of a new pet case, and increase utilization ratio of the original pet case.

### DESCRIPTION OF DRAWINGS

The present disclosure will be described in detail hereinafter in conjunction with drawings and embodiments.

FIG. 1 is a decomposition diagram of a pet case according to an embodiment of the present disclosure.

FIG. 2 is a schematic diagram of a first connector according to an embodiment of the present disclosure. [weiyf1]

FIG. 3 is a schematic diagram of a second connector according to an embodiment of the present disclosure [weiyf2]

Reference numbers in the drawings are listed as the following:

11: side plate; 12: bottom plate; 13: top plate; 2: first connector; 21: first mounting groove; 22: first elastic sealing bulge; 23: first through-hole; 3: first fixed rod; 4: second connector; 41: second mounting groove; 42: second elastic sealing bulge; 43: second through-hole; 5: second fixed rod.

### DETAILED DESCRIPTION

In order to make the technical problem solved by the present disclosure, the technical solution adopted by the present disclosure and the technical effect achieved by the present disclosure more clear, the technical solution of the embodiment of the present disclosure will be described in detail hereinafter in conjunction with the drawings. apparently, the embodiment described is only a part of embodiments of the present disclosure, not all of them. Based on the embodiment of the present disclosure, all other embodiments obtained by those skilled in the art without creative labor are within the protection scope of the present disclosure.

Unless otherwise expressly specified and limited herein, in the description of the present disclosure, the terms “connected”, “connect” and “fixed” should be generally understood. For example, it should be generally understood as fixed connection, detachable connection, or integral connection; it should be generally understood as mechanical connection or electric connection; it should be generally understood as directly connected, indirectly connected through an intermediate medium, internal communication between two elements, or interaction between two elements. For those skilled in the art, a specific meaning of the above terms in the present disclosure may be understood according to a specific condition.

Unless otherwise expressly specified and limited herein, in the present disclosure, that a first feature is “over” or “under” a second feature may include direct contact between the first feature and the second feature, or may include indirect contact between the first feature and the second feature through another feature. In addition, that the first feature is “over”, “above” or “on” the second feature includes that the first feature is right above or obliquely above the second feature, or simply means that the level of the first feature is higher than the level of the second feature. That the first feature is “under”, “below” or “beneath” the second feature includes that the first feature is right below or obliquely below the second feature, or simply means that the level of the first feature is lower than the level of the second feature.

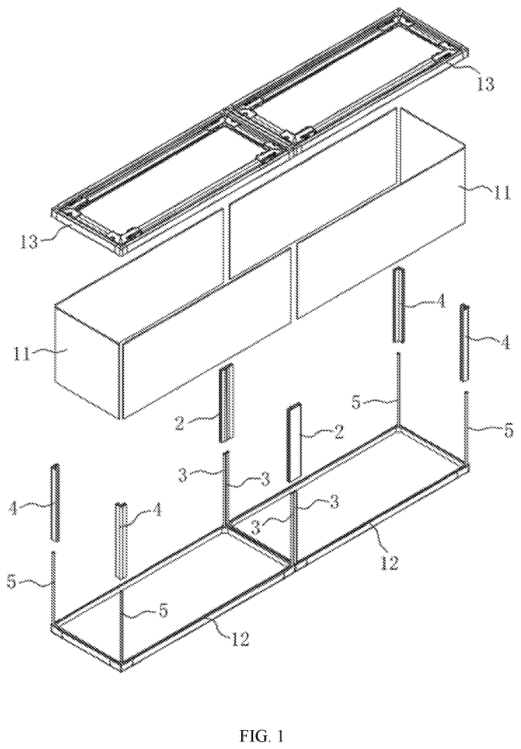

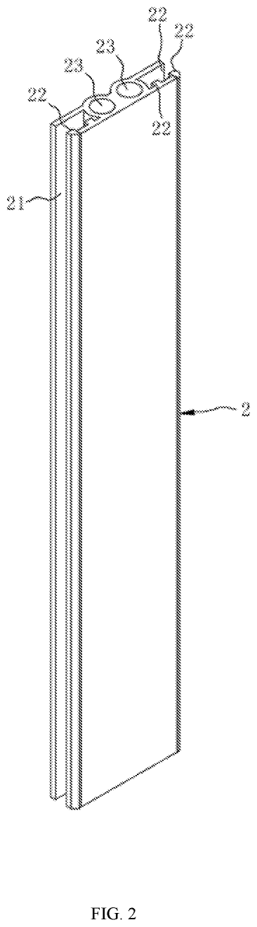

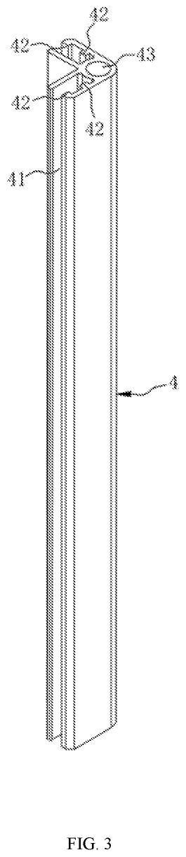

As shown in FIG. 1 to FIG. 3, in the embodiment of the present disclosure, a pet case includes at least two case bodies fitted together. Two adjacent case bodies of the at least two case bodies are communicated to each other, a first connector 2 is arranged between the two adjacent case bodies, and the first connector 2 is connected to a side plate 11 of each of the two adjacent case bodies.

The at least two case bodies are combined to form the pet case through the first connector 2, which may increase the space of the pet case on the basis of effectively using the original pet case, avoid a situation that the original pet case is abandoned due to the insufficiency of space in the pet case and the replacement of a new pet case, and increase utilization ratio of the original pet case.

In the embodiment of the present disclosure, the first connector 2 is provided with a first mounting groove 21 corresponding to the side plate 11 of the each of the two adjacent case bodies.

Through providing the first connector 2 with the first mounting groove 21, it is convenient to position the side plate 11 when the at least two case bodies are combined into the pet case, and to limit the side plate 11 of the each of the two adjacent case bodies to the first mounting groove 21 to avoid side displacement and structural instability.

In an example, a sidewall of the first mounting groove 21 is provided with multiple first elastic sealing bulges 22 along a length direction of the first mounting groove 21.

Through providing the side wall of the first mounting groove 21 with the multiple first elastic sealing bulges 22, connecting stability between the first connector 2 and the side plate 11 may be enhanced to avoid the shaking of the side plate 11 in the first mounting groove 21.

In the embodiment of the present disclosure, a bottom plate 12 of each of the at least two case bodies is provided with a first fixed rod 3 corresponding to the first connector 2, the first connector 2 is provided with a first through-hole 23 corresponding to the first fixed rod 3, and the first fixed rod 3 is configured to pass through the first through-hole 23.

Through providing the bottom plate 12 of each of the at least two case bodies with the first fixed rod 3, providing the first connector 2 with a through-hole, and configuring the first fixed rod 3 to pass through the first connector 2 during installation, it is convenient to implement installation of the pet case, and to simultaneously implement positioning and fixing of the first connector 2, so that movement of the first connector 2 can be avoided when it is subjected to external force, and structure stability of the pet case can be ensured.

In one example, the bottom plate 12 of each of two case bodies that is used to form the pet case is provided with the first fixed rod 3, and the first connector 2 is provided with two first through-holes 23 respectively corresponding to two first fixed rods 3.

In one embodiment, a first screw hole is arranged at each of both ends of the first fixed rod 3, and the bottom plate 12 and a top plate 13 of each of the at least two case bodies are respectively provided with a fixed bolt corresponding to the first screw hole.

Through providing the bottom plate 12 and the top plate 13 with the fixed bolt respectively, the first fixed rod 3 may be fixedly connected to the bottom plate 12 and the top plate 13, which may effectively fix the first fixed rod 3 on the at least two case bodies and ensure the structure stability of the at least two case bodies.

In a specific example, the first connector 2 is a long strip board. Two side faces of the long strip plate are respectively provided with the first mounting groove 21 along a width direction of the long strip plate, and two first through holes are disposed inside of the long strip plate along a length direction of the long strip plate.

In the embodiment of the present disclosure, a second connector 4 is arranged between two adjacent side plates 11 of each of the at least two case bodies, and the second connector 4 is L-shaped.

Connection between the two adjacent side plates 11 of each of the at least two case bodies may be implemented through the L-shaped second connector 4. This is convenient to install the side plates 11 of each of the at least two case bodies, and simplify connection among the side plates 11 of each of the at least two case bodies to enable assembly of the pet case to be easy.

In one embodiment, the second connector 4 is provided with two second mounting grooves 41 respectively corresponding to the two adjacent side plates 11.

Through providing the second connector 4 with the two second mounting grooves 41, the positioning of the two adjacent side plates 11 may be implemented. This may facilitate the installation of the pet case and ensure precision of the installation of the pet case.

In one embodiment, a sidewall of each of the two second mounting groove 41 is provided with multiple second elastic sealing bulges 42 along a length direction of the each of the two second mounting groove 41.

Through providing the two second mounting groove 41 with the multiple second elastic sealing bulges 42, connecting stability between the second connector 4 and the side plates 11 may be enhanced, the shaking of the side plates 11 in the second mounting groove 41 may be avoided, and precision of the installation between the side plates 11 and the second connector 4 may be ensured.

In a specific example, the bottom plate 12 of each of the at least two case bodies is provided with a second fixed rod 5 corresponding to the second connector 4, the second connector 4 is provided with a second through-hole 43 corresponding to the second fixed rod 5, and the second fixed rod 5 is configured to pass through the second through-hole 43.

Through providing the bottom plate 12 of each of the at least two case bodies with the second fixed rod 5, providing the second connector 4 with a corresponding through-hole, and configuring the second fixed rod 5 to pass through the second connector 4, it is convenient to implement the installation of the pet case, and to simultaneously implement positioning and fixing of the second connector 4, so that movement of the second connector 2 can be avoided when it is subjected to external force, and the structural stability of the pet case can be ensued.

In one embodiment, the structure of the first fixed rod 3 is the same as the structure of the second fixed rod 5, and the aperture of the first through-hole 23 is the same as the aperture of the second through-hole 43.

In the embodiment of the present disclosure, the side plate 11 is made of an acrylic plate or a tempered glass plate, and an edge position of the side plate 11 is provided with a protective border. The side plate 11 of the pet case is made of an acrylic plate or a tempered glass plate, which may facilitate an owner to observe the inside of the pet case. The edge position of the side plate is provided with the protective border, which may prevent damage to an assembler or a pet during installation and use. Meanwhile, the strength of the glass plate may be increased and burst under external force may be reduced.

In one embodiment of the present disclosure, four corners of each of the at least two case bodies are respectively provided with the second connector 4, and the side plate 11 of each of the at least two case bodies is installed between two adjacent second connector 4 to form an separate pet case. When the at least two case bodies need to be combined into a larger pet case, only the side plate 11 of each of two adjacent case bodies on a fitted side need to be removed, and the second connectors 4 of each of the two adjacent case bodies on the fitted side are replaced with the first connectors 2, so as to implement a combination of the two adjacent case bodies. This significantly reduces workload of a combination of the at least two case bodies and increases utilization ratio of the at least two case bodies.

In an example, when two case bodies of the at least two case bodies are combined into the pet case, the side plates 11 and the second connector 4 of each of the two case bodies on the fitted side are removed, and the second fixed rod 5 corresponding to the second connector 4 is reserved. Then the side plate 11 of each of the two case bodies is configured to pass through the first connector 2, and the second fixed rod 5 which is not removed from the each of the two case bodies is configured to pass through the first through-hole 23 of the first connector 2. When the first connector 2 is installed, it should be noted that the side plate 11 of each of the two case bodies should be inserted into the first mounting groove 21 of the first connector 2.

When four case bodies of the at least two case bodies are combined in to the pet case, the four case bodies are arranged according to a required arrangement (such as a square array arrangement, a L-shaped arrangement or a straight line arrangement). Then one of the side plates 11 and the second connector 4 of each of the four case bodies on the fitted side are removed, and the second fixed rod 5 corresponding to the second connector 4 is reserved. After that, a side plate 11 of each of two adjacent case bodies of the four case bodies is configured to pass through the first connector 2, and to cause the second fixed rod 5 which is not removed from the each of the two adjacent case bodies to pass through the first through-hole 23 of the first connector 2. It is to be noted that, when the first connector 2 is installed, the side plate 11 of each of the two case bodies should be inserted into a respective first mounting groove 21 of the first connector 2.

For the description of the present disclosure, it should be understood that the terms about orientation or position such as “above”, “below” and “right” are based on orientation or position shown in the attached drawings. This is intended only for ease of description and simplification of operations, rather than for indicating or implying that a referred device or element must have a specific orientation, and be constructed and operated in the specific orientation. Therefore, it cannot be understood as a limitation to the present disclosure. In addition, the terms “first” and “second” are only used for distinguishing from each other and have no special meaning.

In the description of the specification, the description of the reference terms such as “one embodiment” and “an example” means that a combination of specific features, structures, materials or characteristics described by the embodiment or the example is included in at least one embodiment or example of the present disclosure. In the specification, schematic representation for the above terms does not necessarily refer to the same embodiment or example. In addition, it should be understood that although the specification is described in accordance with implementations, it does not means that each of the implementations contains only a separate technical solution. This kind of description of the specification is only for clarity. Those skilled in the art should take the specification as a whole. The technical solutions in the embodiments may also be appropriately combined to form other embodiments that can be understood by those skilled in the art.

The technical principle of the present disclosure is described hereinbefore in conjunction with the specific embodiments. These descriptions are only for interpreting the principle of the present disclosure, but are not to be interpreted in any way as limitation to the protection scope of the present disclosure. Based on the interpretation here, other specific implementations of the present disclosure obtained by those skilled in the art without creative labor will fall within the protection scope of the present disclosure.

What is claimed is:

1. A pet case, comprising: at least two case bodies fitted together, wherein two adjacent case bodies of the at least two case bodies are communicated to each other, a first connector is arranged between the two adjacent case bodies, and the first connector is connected to a side plate of each of the two adjacent case bodies.

2. The pet case of claim 1, wherein the first connector is provided with a first mounting groove corresponding to the side plate of the each of the two adjacent case bodies.

3. The pet case of claim 2, wherein a sidewall of the first mounting groove is provided with a first elastic sealing bulge along a length direction of the first mounting groove.

4. The pet case of claim 1, wherein a bottom plate of each of the at least two case bodies is provided with a first fixed rod corresponding to the first connector, the first connector is provided with a first through-hole corresponding to the first fixed rod, and the first fixed rod is configured to pass through the first through-hole.

5. The pet case of claim 4, wherein a first screw hole is arranged at each of both ends of the first fixed rod, and the bottom plate and a top plate of each of the at least two case bodies are respectively provided with a fixed bolt corresponding to the first screw hole.

6. The pet case of claim 1, wherein a second connector is arranged between two adjacent side plates of each of the at least two case bodies, and the second connector is L-shaped.

7. The pet case of claim 6, wherein the second connector is provided with two second mounting grooves respectively corresponding to the two adjacent side plates.

8. The pet case of claim 6, wherein a bottom plate of each of the at least two case bodies is provided with a second fixed rod corresponding to the second connector, the second connector is provided with a second through-hole corresponding to the second fixed rod, and the second fixed rod is configured to pass through the second through-hole.

9. The pet case of claim 7, wherein a sidewall of each of the two second mounting groove is provided with a second elastic sealing bulge along a length direction of the each of the two second mounting groove.

10. The pet case of claim 1, wherein the side plate is made of an acrylic plate or a tempered glass plate, and an edge position of the side plate is provided with a protective border.
